(19) United States
(12) Patent Application Publication
(10) Pub. No.: US 2017/0196349 A1
(43) Pub. Date: Jul. 13, 2017

(54) ADAPTABLE PAINT APPLICATION SYSTEM

(71) Applicant: Felix Adorno, Staten Island, NY (US)

(72) Inventor: Felix Adorno, Staten Island, NY (US)

(21) Appl. No.: 15/404,857

(22) Filed: Jan. 12, 2017

Related U.S. Application Data
(60) Provisional application No. 62/278,059, filed on Jan. 13, 2016.

(51) Int. Cl. A46B 5/00; B25G 3/28; A46B 9/02; B25G 1/04; A46B 3/02; A46B 3/06

(52) U.S. Cl. CPC A46B 5/0095; A46B 3/02; A46B 3/06; A46B 9/025; B25G 1/04; B25G 3/28; A46B 2200/202

(57) ABSTRACT

An adaptable paint application system has a handle member structured to have a mortise opening for accepting a tenon member of a replaceable paint applicator mounting element. The replaceable paint applicator mounting element has a paint applicator mounting block bonded to the tenon member. Bristles may be adhered to the paint applicator mounting block. The tenon member may have a first and a second concave hemispherical indentation for receiving first and second mating convex hemispherical protuberances. Alternately, the tenon member includes a stud connector that is forcibly inserted in a socket connector on mortice opening of the handle member. The handle member has a threaded opening for receiving a threaded end of an extension handle. The paint applicator mounting block may have a threaded opening for receiving a threaded end of a frame of a paint roller or pad.

This application claims benefit under 35 U.S.C. §119 to U.S. Provisional Patent Application Ser. No. 62/278,059, filed on Jan. 13, 2016, which is herein incorporated by reference in its entirety.

### TECHNICAL FIELD

This disclosure relates generally to a paint application device and more particularly to an adaptable paint application system having a handle that receives replaceable paint application elements containing a brush bristle packet, a paint roller or other paint applicators.

### BACKGROUND

Painting ceilings or difficult heights can only be done with the use of a ladder. For the professional and do-it-yourself painter, working with ladders is always considered a potentially hazardous activity. Even painting base molding at floor level requires one to be on their hands and knees thus causing fatigue and joint strain. Another irritation for the user when working with multiple colors is the need for multiple brushes.

One problem with paint brushes used for painting of large surface areas is that paint will accumulate within the bristles of the brush, particularly in the area near the ferrule that clamps the bristles together and joins them with the paint brush handle. The collected paint in the bristles near the ferrule is practically impossible to clean and some residual paint is generally left in the bristles at the junction with the ferrule and bristles. The dried paint builds up over time with repeated use of the paint brush causing the bristles of the brush to spread. The spreading reduces the life of the paint brush, also requiring multiple brushes.

### SUMMARY

An object of this disclosure is to provide an adaptable paint application system with a mortice and tenon structure for joining and locking a paint applicator and a handle of the adaptable paint application system together.

Another object of this disclosure is to provide a method of assembly of an adaptable paint application system with a mortice and tenon structure for joining and locking a paint applicator and a handle of the adaptable paint application system together.

To accomplish at least one of these objects, an adaptable paint application system has a handle member structured to have a mortise opening for accepting a tenon member of a replaceable paint applicator mounting element. The adaptable paint application system includes at least one replaceable paint applicator mounting element, wherein in various embodiments, the paint applicator mounting element has a paint applicator mounting block that is coupled to the tenon member.

One embodiment of a replaceable paint applicator has a plurality of bristles adhered to the paint applicator mounting block. In some embodiments where the bristles are formed of a synthetic material produced of organic polymers such as polyethylene, polyvinyl-chloride (PVC), nylon, or any other polymeric fibrous compound. The bristles are then adhesively attached to the paint applicator mounting block either by solvent welding, hot air plastic welding, or ultrasonic spot welding or applying adhesives (epoxy or cyanoacrylate). In various embodiments, the paint applicator mounting block is configured for placing the tip ends of the bristles at an angle of approximately 35°. The approximately 35° angle permits a user of the adaptable paint application system better control at a ceiling line by improving the sight lines for aiding in producing a straight line.

In various embodiments, the tenon member has a first concave hemispherical indentation placed centrally on a front surface and a second concave hemispherical indentation placed on a back surface of the tenon member. The first and second concave indentations are configured receiving a first and second mating convex hemispherical protuberances that are formed with the mortice opening. The first and second mating convex hemispherical protuberances are placed on a first longer side wall and a second longer side wall of the mortice opening to mate with the first and second concave indentations.

In other embodiments, the tenon member includes a stud connector located at a bottom side of the tenon member that is forcibly placed in a socket connector constructed as part of the mortice opening of the handle member.

In some embodiments, the handle member has a threaded opening placed at an end of the handle member opposite the mortice opening. The threaded opening is configured for receiving a threaded end of an extension handle. The extension handle allows the user to reach a ceiling for painting trim and other features of the ceiling of a room.

In various embodiments, the paint applicator mounting block has a threaded opening on its top surface for receiving a threaded end of a frame of a paint roller or pad. The frame is configured for accepting a paint roller or a painting pad for application of paint to a surface of a room.

### BRIEF DESCRIPTION OF THE DRAWINGS

FIG. 1a is a diagram of a front view of an adaptable paint application system embodying the principals of this disclosure.

FIG. 1b is a diagram of a side view of an adaptable paint application system embodying the principals of this disclosure.

FIG. 1c is a diagram of an isometric view of an adaptable paint application system embodying the principals of this disclosure.

FIG. 1d is a diagram of an isometric view of a paint applicator mounting block of the adaptable paint application system of FIGS. 1a, 1b, and 1c embodying the principals of this disclosure.

FIGS. 2a and 2b are respectively a front view and side view of a paint applicator mounting block embodying the principals of this disclosure accepting a paint roller.

FIG. 3 is a drawing of a person using the adaptable paint application system embodying the principals of this disclosure for painting an elevated region of a room.

FIGS. 4a and 4b are diagrams of a second embodiment of the adaptable paint application system embodying the principals of this disclosure.

FIGS. 5a and 5b are diagrams of a third embodiment of the adaptable paint application system embodying the principals of this disclosure.

FIG. 6 is a flow chart for a method of fabrication for the adaptable paint application system embodying the principals of this disclosure.

### DETAILED DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

As is known in the art, paint brushes are constructed of a wooden or plastic handle, a set of bristles, and a ferrule that holds the bristles together and to the handles. The bristles may be animal hair or synthetic fibers such as nylon or polyester.

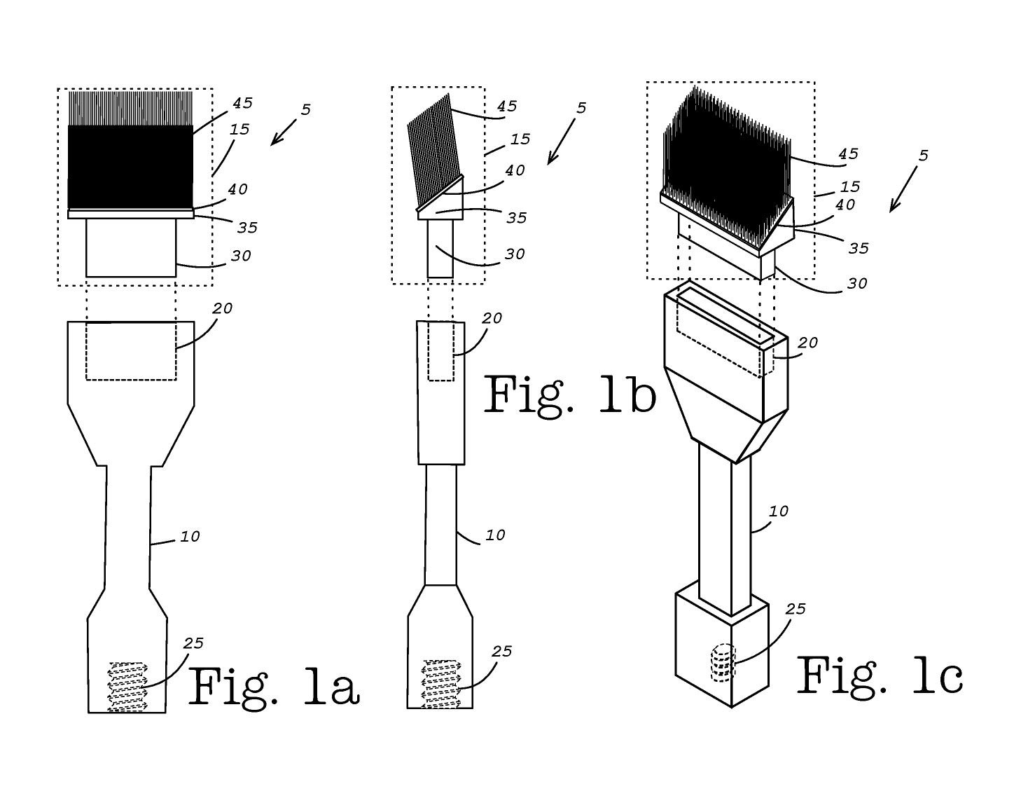

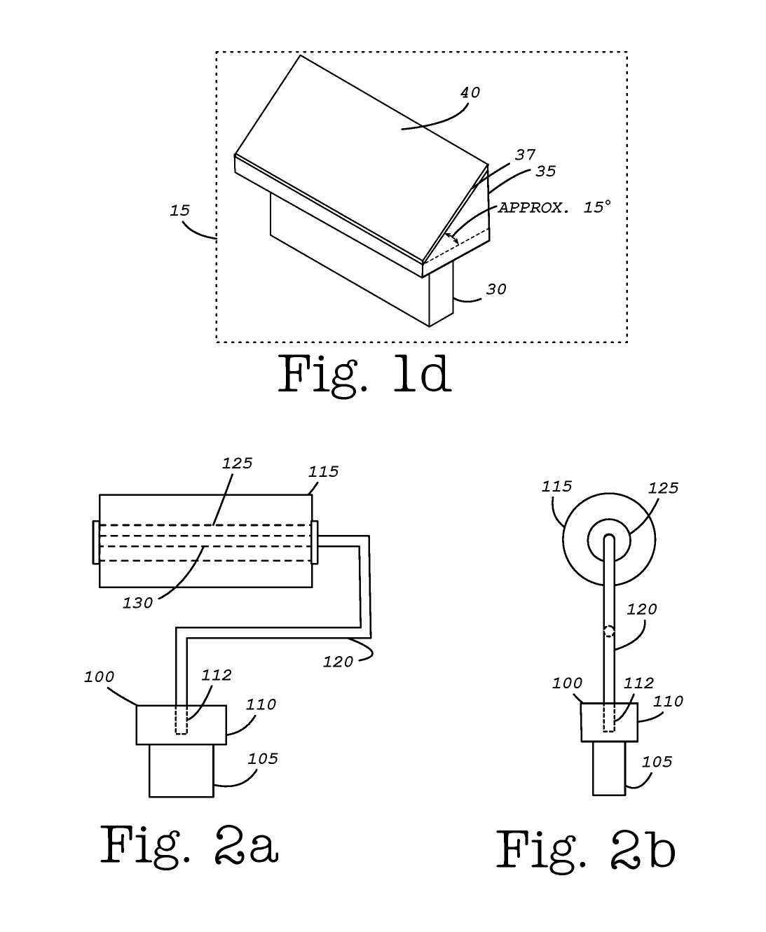

FIGS. 1a, 1b, and 1c are diagrams, respectively, of a front view, a side view, and an isometric view of an adaptable paint application system 5 embodying the principals of this disclosure. The adaptable paint application system 5 has a handle 10 that may be injection molded or three-dimensionally (3D) printed using appropriate synthetic materials. The handle 10 has a mortice opening 20 at the top surface that is structured for accepting a tenon member 30 of a paint applicator mounting block 15. The paint applicator mounting block 15 may be similarly injection molded or 3D printed using appropriate synthetic materials. The mortice opening 20 is constructed to be such that the tenon member 30 is locked into place such that the paint applicator mounting block 15 is not movable during use.

The handle 10 of the adaptable paint application system 5 has a threaded opening 25 at an opposing end from the mortice opening 20. The threaded opening 25 is configured for accepting an extension handle (discussed hereinafter) with a mating threaded end on the extension handle.

In various embodiments, the paint applicator mounting block 15 has a bristle tip adapter block 35 that is bonded with the tenon member 30. A plurality of bristles 45 are assembled into a grouping and fused to the bristle tip adapter block 35 to form a joint 40 with the plurality of bristles. The joint 40 is formed with a solvent weld or an adhesive. Instances where the bristles are synthetic fibers such as nylon on polyester, the solvent weld 40 is preferable for a more durable joint. For natural animal hair fibers, an adhesive is used for forming the joint 40 between the plurality of bristles and the bristle tip adapter block 35

FIG. 1d is a diagram of an isometric view of a paint applicator mounting block 15 of the adaptable paint application system of FIGS. 1a, 1b, and 1c without the plurality of bristles 45. This implementation of the paint applicator mounting block 15 has the top surface 37 of the bristle tip adapter block 35 set at approximately a 15°. The angle as set allows the user more control at the ceiling line and improves the sight aiding in producing straight lines.

FIGS. 2a and 2b are respectively a front view and side view of a paint applicator mounting block 100 accepting a paint roller 115. The paint applicator mounting block 100 has a tenon member 105 that is essentially identical to the tenon member 30 of FIGS. 1a, 1b, and 1d. An appliance attachment block 110 is bonded to the tenon member 105 similarly to that of the tenon member 30 as described above. An opening 112 is formed in the appliance attachment block 110 to receive a frame extension member 120 of the paint roller 115. The frame extension member 120 is secured to the appliance attachment block 110 by threading the opening 112 to receive a threaded end of the frame extension member 120. Alternately, the frame extension member 120 may be secured to the appliance attachment block with an adhesive. The frame extension member 120 is connected to a roller frame 125 as is known in the art. A roller sleeve 130 is slid over the roller frame 125 for applying paint to a surface.

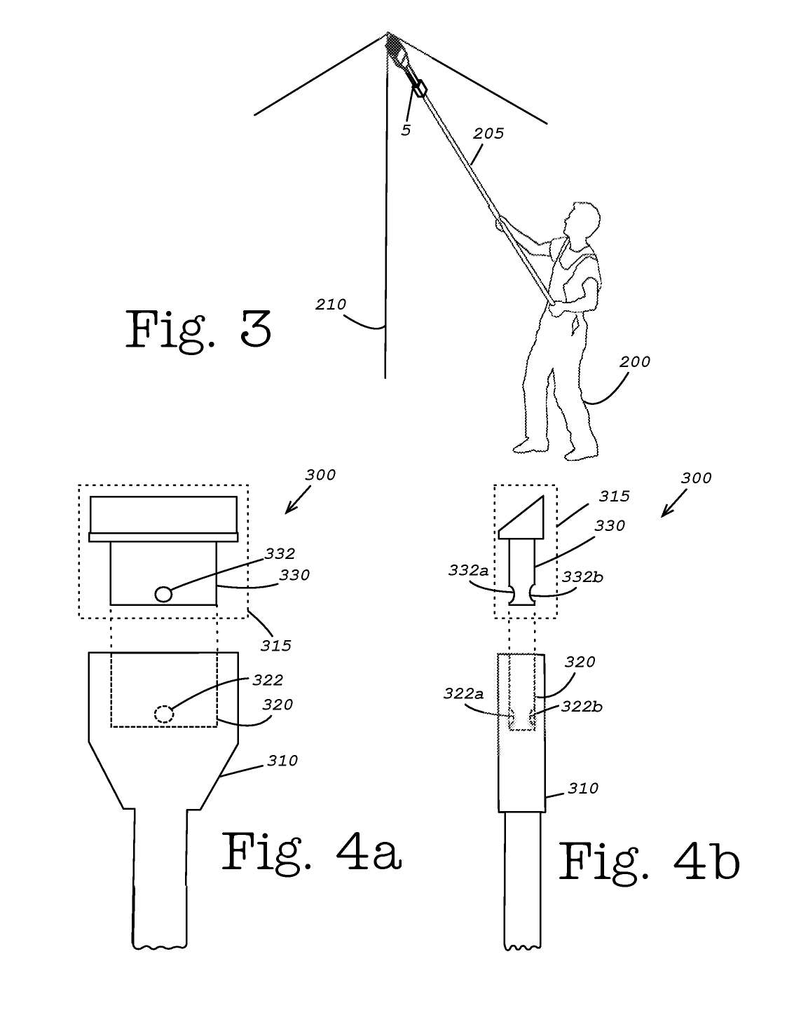

FIG. 3 is a drawing of a person 200 using the adaptable paint application system 5 for painting an elevated region of a room 210. The adaptable paint application system 5 has an extension handle 205 threaded into the threaded opening 25 of the handle 10 of the adaptable paint application system 5. This allows the person 200 to accurately trim the edges of the walls of the room 210 at their upper edges where they join the ceiling or beyond the reach of the person 200.

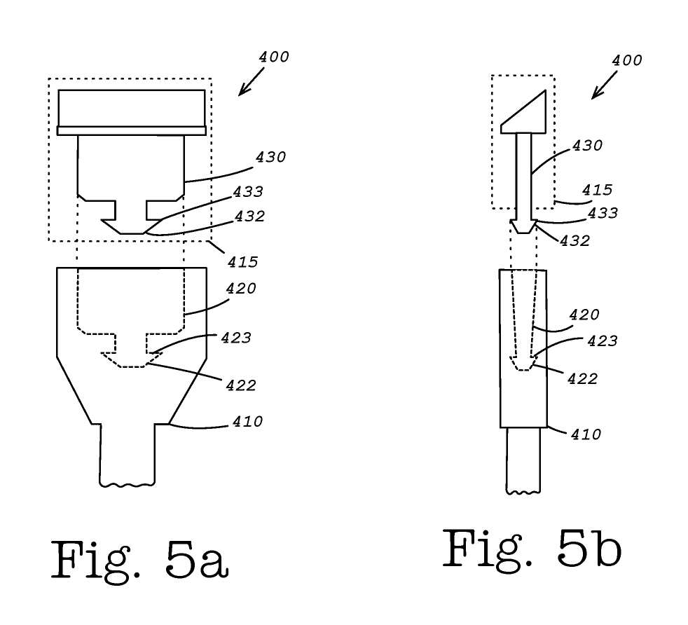

FIGS. 4a and 4b are diagrams of a second embodiment of the adaptable paint application system 300. The handle 310 is identical to the handle 10 of FIGS. 1a, 1b, and 1c with the exception that the mortice opening 320 includes depressable domed extensions 322 (322a and 322b in FIG. 4b) on the opposing walls of the mortice opening 320. The paint applicator mounting block 315 is identical to that of the paint applicator mounting block 15 of FIGS. 1a, 1b, and 1c with the exception that the tenon member 330 has hemispherical indentations 332 (332a and 332b in FIG. 4b) that mate with the depressable domed extensions 322a and 322b when the tenon member 330 is placed in the mortice opening 320. When the depressable domed extensions 322a and 322b link with the hemispherical indentations 332a and 332b, the depressable domed extensions 322a and 322b expand to lock the tenon member 330 in place. The paint applicator mounting block 315 is prevented from moving to permit accurate control of the paint applicator (bristles 45 of FIGS. 1a, 1b, and 1c or the paint roller 115 of FIGS. 2a and 2b).

FIGS. 5a and 5b are diagrams of a third embodiment of the adaptable paint application system 400. The handle 410 is identical to the handle 10 of FIGS. 1a, 1b, and 1c with the exception that the mortice opening 420 includes socket connector 422 at the bottom of the mortice opening 420. The paint applicator mounting block 415 is identical to that of the paint applicator mounting block 15 of FIGS. 1a, 1b, and 1c with the exception that the tenon member 430 has a stud connector 432 that mates with the socket connector 422 when the tenon member 430 is placed in the mortice opening 420. When the stud connector 432 links with the socket connector 422, the stud connector 432 passes over the latching mechanism of the socket connector 422 to lock the tenon member 430 in place. The paint applicator mounting block 415 is prevented from moving to permit accurate control of the paint applicator (bristles 45 of FIGS. 1a, 1b, and 1c or the paint roller 115 of FIGS. 2a and 2b).

In a preferred implementation of the third embodiment of the adaptable paint application system 400, the socket connector 422 and the stud connector 432 are snap-fit fasteners. Snap-fit fasteners have a protruding part 433 of the stud connector 432, e.g., a hook, stud or bead that is deflected briefly during the joining operation and catches in an undercut depression 423 in the mating socket connector 422. After the joining operation, the snap-fit features return to a stress-free condition. The joint of the stud connector 432 with the socket connector 422 is separable based on the shape of the undercut 423. The force required to separate the socket connector 422 and the stud connector 432 varies greatly according to the design.

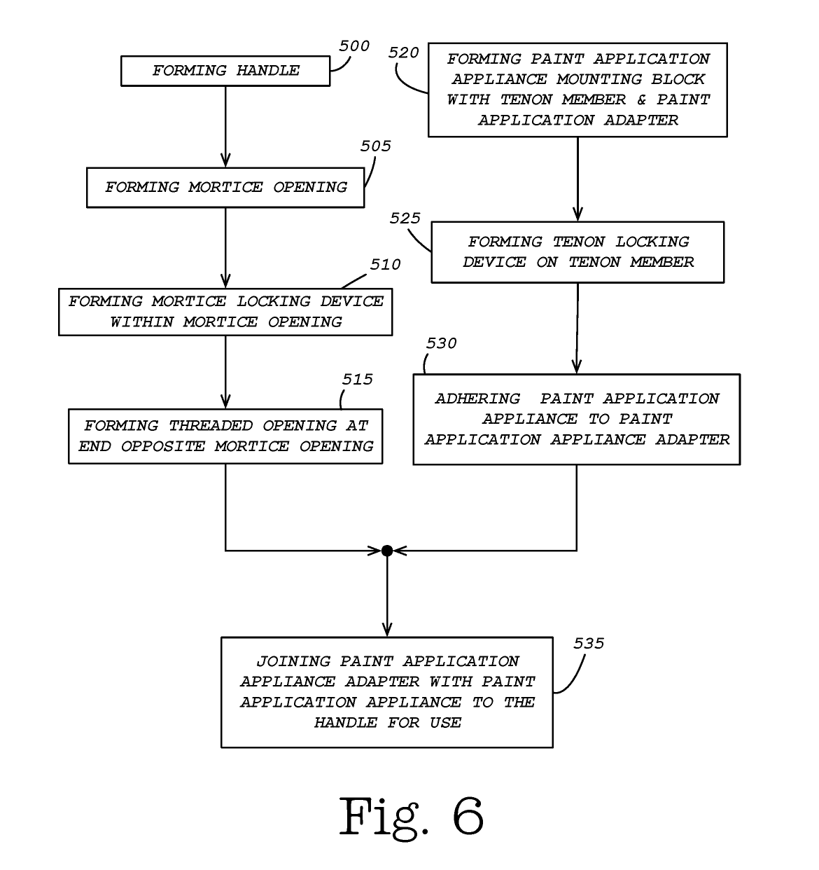

FIG. 6 is a flow chart for a method of fabrication for an adaptable paint application system. Refer now to FIGS. 1a, 1b, 1c, and 6. The method fabrication begins with separately forming (Box 500) a handle 10 of the adaptable paint application system and forming (Box 520) a paint applicator mounting block 15. The handle 10 may be injection molded or three-dimensionally (3D) printed with appropriate synthetic materials. A mortice opening 20 is formed (Box 505) at the top surface of handle 10 and configured for accepting a tenon member 30 of a paint applicator mounting block 15. A mortice locking device (322 of FIG. 4a or 422 of FIG. 5a) is formed (Box 510) within the mortice opening 20 for securing the tenon member 30 when it is placed within the mortice opening 20 such that the paint applicator mounting block 15 is not movable during use. A threaded opening 25 is formed (Box 515) in the handle 10 at an opposing end from the mortice opening 20. The threaded opening 25 is configured for accepting an extension handle 205 of FIG. 3 with a mating threaded end on the extension handle.

The forming (Box 520) of the paint applicator mounting block 15 may be similarly injection molding or 3D printed using appropriate synthetic materials. A tenon locking device (332 of FIG. 4a or 432 of FIG. 5a) is formed (Box 525) on the tenon for locking the paint applicator mounting block 15 to the handle to secure the paint applicator mounting block 15 to handle 10 to prevent movement.

Once the handle 10 and the paint applicator mounting block 15 with its paint applicator (45 in FIGS. 1a, 1b, and 1c, and 115 in FIGS. 2a and 2b) are fabricated they will ultimately be joined (Box 535) for use.

While this disclosure has been particularly shown and described with reference to the preferred embodiments thereof, it will be understood by those skilled in the art that various changes in form and details may be made without departing from the spirit and scope of the disclosure. As an example, the paint applicator may be a foam pad adhered to a substrate that in turn is connected to the paint applicator mounting block 15. Any such paint applicator will embody the principals of this disclosure.

What is claimed is:

1. An adaptable paint application system comprising:
a handle member structured to have a mortise opening at a first end of the handle; and
at least one replaceable paint application element comprising:
a paint applicator mounting block, and
a tenon member bonded to the paint application mounting block configured for fitting and locking within the mortice opening of the handle member.

2. The adaptable paint application system of claim 1 wherein the handle member is fabricated by injection molding or three-dimensionally (3D) printing of synthetic or composite materials.

3. The adaptable paint application system of claim 1 wherein the handle further comprises a threaded opening formed at a second opposing the first end of the handle configured for receiving a threaded extension handle.

4. The adaptable paint application system of claim 1 wherein the mortice opening comprises a first and second mating convex hemispherical protuberance formed on opposing longitudinal sides of the mortice opening for locking the tenon member to prevent movement.

5. The adaptable paint application system of claim 4 wherein the tenon member comprises first concave hemispherical indentation placed centrally on a first longitudinal surface and a second concave hemispherical indentation placed on a second longitudinal surface of the tenon member, wherein the first and second concave hemispherical indentations on the tenon member receive the first and second mating convex hemispherical protuberances in the mortice opening to lock the replaceable paint application element in place.

6. The adaptable paint application system of claim 1 wherein the mortice opening comprises a socket connector constructed at a lower portion of the mortice opening of the handle member for locking the tenon member to prevent movement.

7. The adaptable paint application system of claim 6 wherein the tenon member comprises a stud connector located at a bottom side of the tenon member that is forcibly placed in the socket connector of the mortice opening to lock the replaceable paint application element in place.

8. The adaptable paint application system of claim 1 wherein the replaceable paint application element has a plurality of bristles adhered to the paint applicator mounting block.

9. The adaptable paint application system of claim 8 wherein the plurality of bristles is formed of a synthetic material produced of organic polymers such as polyethylene, polyvinyl-chloride (PVC), nylon, or any other polymeric fibrous compound.

10. The adaptable paint application system of claim 9 wherein the plurality of bristles is then adhesively attached to the paint applicator mounting block.

11. The adaptable paint application system of claim 10 wherein the plurality of bristles is adhesively attached by solvent welding, hot air plastic welding, or ultrasonic spot welding.

12. The adaptable paint application system of claim 10 wherein the plurality of bristles is adhesively attached with epoxy or cyanoacrylate adhesives.

13. The adaptable paint application system of claim 1 wherein the paint applicator mounting block is configured for placing the tip ends of the bristles at an angle of approximately 35° for permitting a user of the adaptable paint application system more control at a ceiling line by improving the sight lines for aiding in producing a straight line.

14. The adaptable paint application system of claim 1 wherein the paint applicator mounting block has a threaded opening on its top surface for receiving a threaded end of a frame of a paint roller or pad.

15. A method for forming an adaptable paint application system comprising steps of:
forming a handle member by the steps of:
fabricating the handle member, and
constructing a mortise opening at a first end of the handle; and
forming at least one replaceable paint application element by the steps of:
constructing a paint applicator mounting block,
constructing a tenon member for fitting and locking within the mortice opening of the handle member, and
bonding the tenon member to the paint application mounting block.

16. The method for forming the adaptable paint application system of claim 15 wherein forming the handle member by the step of fabricating the handle member by injection molding or three-dimensionally (3D) printing of synthetic or composite materials.

17. The method for forming the adaptable paint application system of claim 15 wherein forming the handle further comprises the step of creating a first threaded opening formed at a second opposing the first end of the handle configured for receiving a threaded extension handle.

18. The method for forming the adaptable paint application system of claim 15 wherein constructing the mortice opening comprises the step of fashioning a first and second mating convex hemispherical protuberances on opposing longitudinal sides of the mortice opening for locking the tenon member to prevent movement.

19. The method for forming the adaptable paint application system of claim 18 wherein constructing the tenon member comprises the steps of fashioning a first concave hemispherical indentation placed centrally on a first longitudinal surface and fashioning a second concave hemispherical indentation placed on a second longitudinal surface of the tenon member, wherein the first and concave hemispherical indentation on the tenon member receive the first and second mating convex hemispherical protuberances in the mortice opening to lock the replaceable paint application element in place.

20. The method for forming the adaptable paint application system of claim 15 wherein constructing the mortice opening comprises the step of fashioning a socket connector at a lower portion of the mortice opening of the handle member for locking the tenon member to prevent movement.

21. The method for forming the adaptable paint application system of claim 20 wherein constructing the tenon member comprises the step of fashioning a stud connector located at a bottom side of the tenon member that is forcibly placed in the socket connector of the mortice opening to lock the replaceable paint application element in place.

22. The method for forming the adaptable paint application system of claim 15 wherein the forming the replaceable paint application element comprises the step of:
forming a plurality of bristles; and
adhering the plurality of bristles to the paint applicator mounting block.

23. The method for forming the adaptable paint application system of claim 22 wherein forming the plurality of bristles comprises the step of producing the bristles from a synthetic material produced of organic polymers such as polyethylene, polyvinyl-chloride (PVC), nylon, or other polymeric fibrous compound.

24. The method for forming the adaptable paint application system of claim 23 wherein adhering the plurality of bristles comprises the step of adhesively bonding the plurality of bristles to the paint applicator mounting block.

25. The method for forming the adaptable paint application system of claim 24 wherein adhering the plurality of bristles comprises the step of bonding the plurality of bristles by solvent welding, hot air plastic welding, or ultrasonic spot welding.

26. The method for forming the adaptable paint application system of claim 24 wherein adhering the plurality of bristles comprises the step of adhesively attaching the plurality of bristles with epoxy or cyanoacrylate adhesives.

27. The method for forming the adaptable paint application system of claim 15 wherein constructing the paint applicator mounting block comprises the step of placing the tip ends of the bristles at an angle of approximately 35° for permitting a user of the adaptable paint application system more control at a ceiling line by improving the sight lines for aiding in producing a straight line.

28. The method for forming the adaptable paint application system of claim 15 wherein constructing the paint applicator mounting block comprises the step of fashioning a second threaded opening on its top surface for receiving a threaded end of a frame of a paint roller or pad.
